(19) United States
(12) Patent Application Publication
(10) Pub. No.: US 2010/0175923 A1
(43) Pub. Date: Jul. 15, 2010

(54) ORIENTATION SENSOR FOR DOWNHOLE TOOL

(76) Inventor: Victor Laing Allan, Aberdeenshire (GB)

Correspondence Address: General Electric Company;GE Global Patent Operation, 2 Corporate Drive, Suite 648, Shelton, CT, 06484, US

(21) Appl. No.: 12/602,354

(22) PCT Filed: Apr. 23, 2008
(86) PCT No.: PCT/GB2008/001432

§ 371 Date: Nov. 30, 2009

(30) Foreign Application Priority Data
May 30, 2007 (GB) 0710281.7

(51) Int. Cl. E21B 47/024; G01V 3/00; E21B 7/04

(52) U.S. Cl. 175/45; 340/853.8; 340/854.8

(57) ABSTRACT

A downhole drilling apparatus incorporating an orientation sensor (24) is disclosed. The orientation sensor is mounted to a housing (16) for providing a signal representing the orientation of the housing, and is connected to a first transceiver coil (26). A second transceiver coil (30) and a series of magnets (32) are mounted to a rotary shaft (18). As the shaft rotates relative to the housing, passage of the magnets past the first transceiver coil generates a voltage to provide electrical power to the sensor, and electromagnetic coupling between the first and second transceiver coils enables signals from the sensor to be transmitted to a measurement while drilling tool mounted on the rotary shaft.

### CROSS-REFERENCE TO RELATED APPLICATIONS

This is a national stage application under 35 U.S.C. §371(c)of prior-filed, co-pending PCT patent application serial number PCT/GB2008/001432, filed on Apr. 23, 2008, which claims priority to Great Britain patent application serial number GB0710281.7, filed on May 30, 2007, each of which is hereby incorporated herein by reference in its entirety.

### BACKGROUND OF THE INVENTION

1. Field of the Invention

The present invention relates to an orientation sensor for a downhole tool, and relates particularly, but not exclusively, to an orientation sensor for a rotary steerable tool adapted to be incorporated into a downhole drilling apparatus.

2. Description of Related Art

Rotary steerable tools for incorporation into downhole drilling apparatus are known in which the tool is incorporated within a drill string and includes a non-rotating outer sleeve having one or more retractable pushers for engaging the wall of a borehole formed by the drilling apparatus in order to adjust the orientation of the sleeve relative to the borehole. A hollow shaft defines a passage for drilling fluid and is rotatably mounted within the sleeve and is directly or indirectly connected to a drill bit for forming the borehole, such that operation of the drill bit occurs by means of rotation of the shaft. In order to adjust the direction of drilling of the drilling apparatus, the rotary steerable tool is activated from the surface by adjustment of the pressure of drilling fluid in the hollow shaft, which in turn causes one or more of the pushers to engage the wall of the borehole to adjust the orientation of the non-rotating sleeve relative to the borehole. This in turn adjusts the direction of drilling. In order to effectively control the direction of drilling, the orientation of the pusher or pushers relative to the borehole must be known.

It is known to provide an indication of the orientation of the housing of a downhole tool relative to a borehole by providing one or more accelerometers, which provide an indication of the orientation of the housing relative to the vertical, on a measurement while drilling (MWD) tool connected to the rotating shaft. It has generally been considered necessary to mount the MWD tool and accelerometers to the rotating shaft, because of insufficient space on the non-rotating sleeve during use, and the difficulty/complexity associated with providing power between the rotating shaft and the non-rotating sleeve. However, this provides the disadvantages that because the accelerometers are sensitive to vibration and acceleration, it is generally very difficult or even impossible to obtain signals from the accelerometer mounted to the rotating shaft while the shaft is rotating. As a result, accelerometer signals, and therefore an indication of the orientation of the housing relative to the borehole, can generally only be obtained when the rotary shaft is stationary, or moving slowly, as a result of which orientation indication signals can only be obtained at discrete intervals, and not continuously while the drilling apparatus is in operation, because of undesirability of ceasing drilling.

### BRIEF DESCRIPTION OF THE INVENTION

Preferred embodiments of the present invention seek to overcome one or more of the above disadvantages of the prior art.

According to an aspect of the present invention, there is provided an orientation indicating apparatus for a downhole tool having a first part and a second part adapted to rotate relative to said first part, the apparatus comprising:

at least one orientation sensor adapted to be mounted to said first part for providing a signal representing the orientation of said first part;

signal transmitting means adapted to be mounted to said first part and to be connected to at least one said orientation sensor; and

signal receiving means adapted to be mounted to said second part and to be in electromagnetic communication with said signal transmitting means for receiving a signal provided by at least one said orientation sensor.

This provides the advantage of enabling at least one orientation sensor to be mounted to a non-rotating sleeve of the downhole tool. In the case in which the orientation sensor is an accelerometer, the accelerometer signals are then less prone to disturbance by vibration caused by the rotating shaft, as a result of which the orientation sensor can be used continuously while the shaft is rotating. By providing a signal receiving means in electromagnetic communication with the signal transmitting means, this enables a signal generated by the orientation sensor to be supplied to a measurement while drilling (MWD) tool connected to the rotating shaft, which in turn facilitates communication of the signal to the surface.

At least one said orientation sensor may be an accelerometer.

At least one said orientation sensor may be a magnetic sensor.

Said signal-transmitting means may comprise at least one conductive loop adapted to transmit a signal to said signal receiving means by means of electromagnetic induction.

Said signal receiving means may be adapted to enable power to be transmitted to said sensor by means of electromagnetic induction.

This provides the advantage that the orientation sensor does not require a separate power supply, which further provides the advantage that difficult and inconvenient replacement of the power supply is avoided.

The signal receiving means may comprise at least one conductive loop.

The signal receiving means may further comprise at least one magnetic material surrounded by at least one said conductive loop.

At least one said magnetic material may be a ferromagnetic material.

The signal receiving means may further comprise at least one magnet.

The signal receiving means may comprise at least one antenna adapted to receive a varying electrical signal.

This provides the advantage that a single component for transmitting power to the sensor and receiving signals from the sensor can be used.

According to another aspect of the present invention, there is provided a downhole tool comprising:

a housing adapted to be mounted in a drilling apparatus for forming a borehole;

a hollow shaft defining a passage for drilling fluid, wherein at least part of said shaft is rotatably mounted in said housing; and

an orientation indicating apparatus as defined above, wherein at least one said orientation sensor and said signal transmitting means are mounted to said housing and said signal receiving means is mounted to said hollow shaft.

The tool may further comprise at least one borehole engaging component mounted to said housing and displaceable relative thereto to engage a wall of a borehole formed by a drilling apparatus incorporating said downhole tool, in order to adjust the direction of drilling of said drilling apparatus.

### BRIEF DESCRIPTION OF THE DRAWINGS

Preferred embodiments of the invention will now be described, by way of example only and not in any limitative sense, with reference to the accompanying drawings, in which:

FIG. 1 is a schematic representation of a drilling apparatus incorporating a rotary steerable tool embodying the present invention;

FIG. 2 is a cross sectional detailed view of a first embodiment of the rotary steerable tool of FIG. 1;

FIG. 3 is a cross sectional detailed view of a second embodiment of the rotary steerable tool of FIG. 1; and

FIG. 4 is a schematic representation of electrical components of the rotary steerable tool of FIGS. 1 to 3.

### DETAILED DESCRIPTION OF THE INVENTION

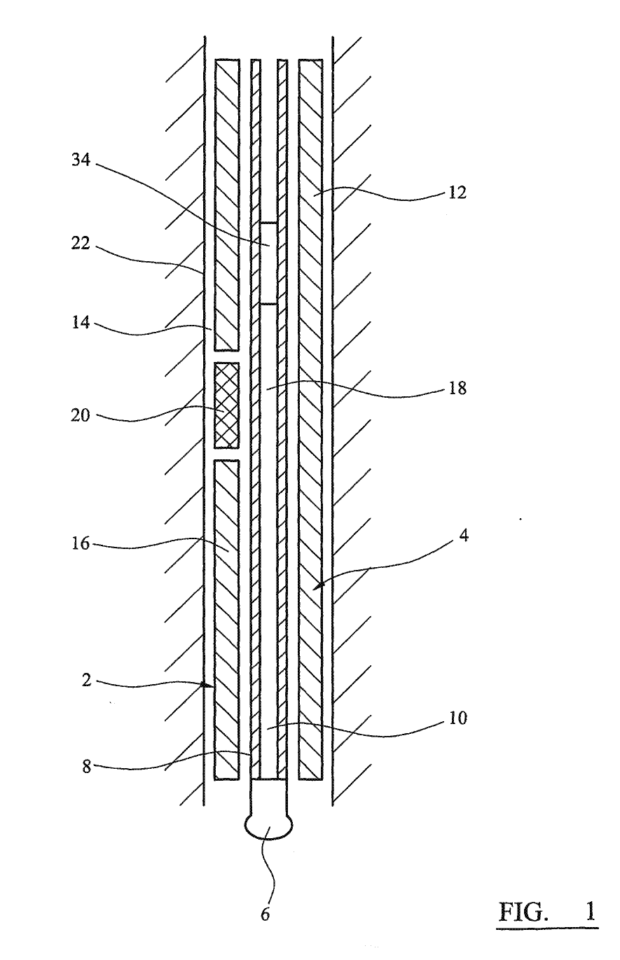

Referring to FIG. 1, a downhole drilling apparatus 2 in the form of a drill string incorporating a rotary steerable tool 4 embodying the present invention has a drill bit 6 mounted to a hollow shaft 8 defining a passage 10 for transmitting drilling fluid to the drill bit 6, and an outer housing 12 to which the shaft 8 is mounted, and which defines an annular chamber 14 for enabling drilling fluid and drilling debris to return to the surface from the drill bit 6. The outer housing 12 is connected to the shaft 8 by means of a clutch (not shown) for causing the housing 12 to rotate with the shaft 8 when the tool 4 is in its orienting mode, or straight drilling mode in order to improve the drilling efficiency of the apparatus 2, and for enabling the shaft 8 to rotate relative to the outer housing 12 when the tool 4 is in its directional drilling mode. In the orienting mode of the tool 4, the housing 12 and shaft 8 are locked together and accelerometers (described in greater detail below) either provided on a measurement while drilling (MWD) tool on the shaft 4 or on the outer sleeve 12 can be used to monitor the angle of the tool 4 from vertical in order to correctly orient the tool 4 prior to excitation (i.e. cycle of pumps) of drilling fluid. This is achieved by rotating the tool 4 slowly clockwise and reading the angular position at the surface until the tool 4 is positioned correctly.

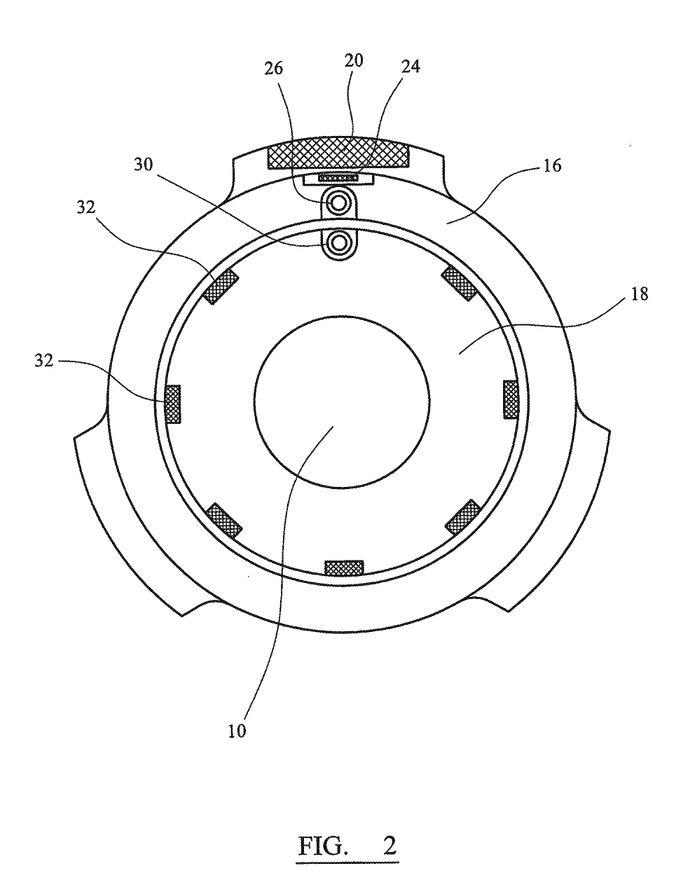

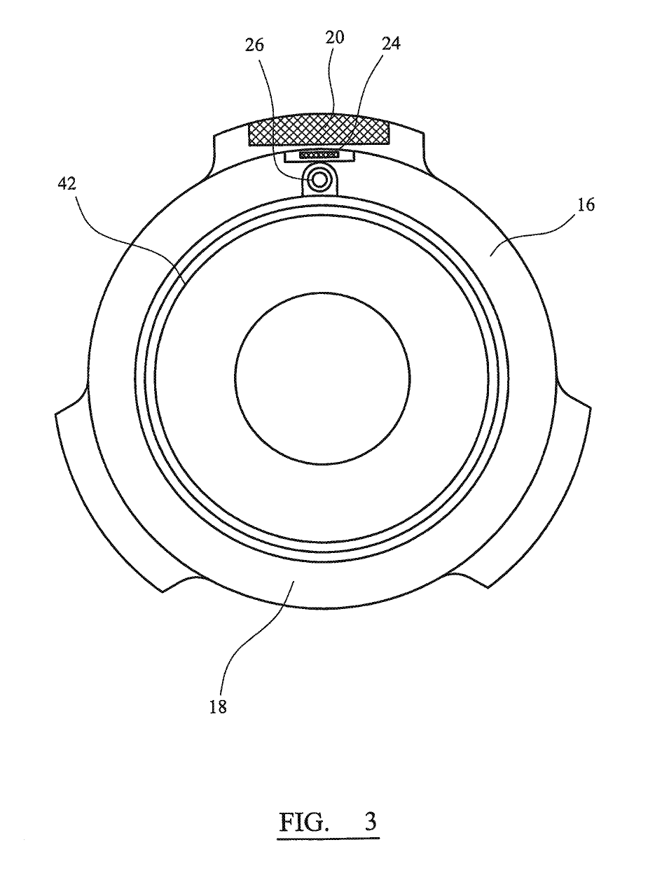

The rotary steerable tool 4 has an outer housing 16, which forms part of the outer housing 12 of the drilling apparatus 2, and a rotary shaft mounted 18 within the housing 16. A series of pushers 20 (only one of which is shown in FIGS. 2 and 3) are mounted at equiangularly spaced positions around the housing 16, and are displaceable outwards of the housing to engage the wall 22 of the borehole to adjust the direction of drilling of the drilling apparatus 2. The retracted or protruding condition of the pushers 20 can be controlled by controlling the pressure of drilling fluid in the hollow shaft 8.

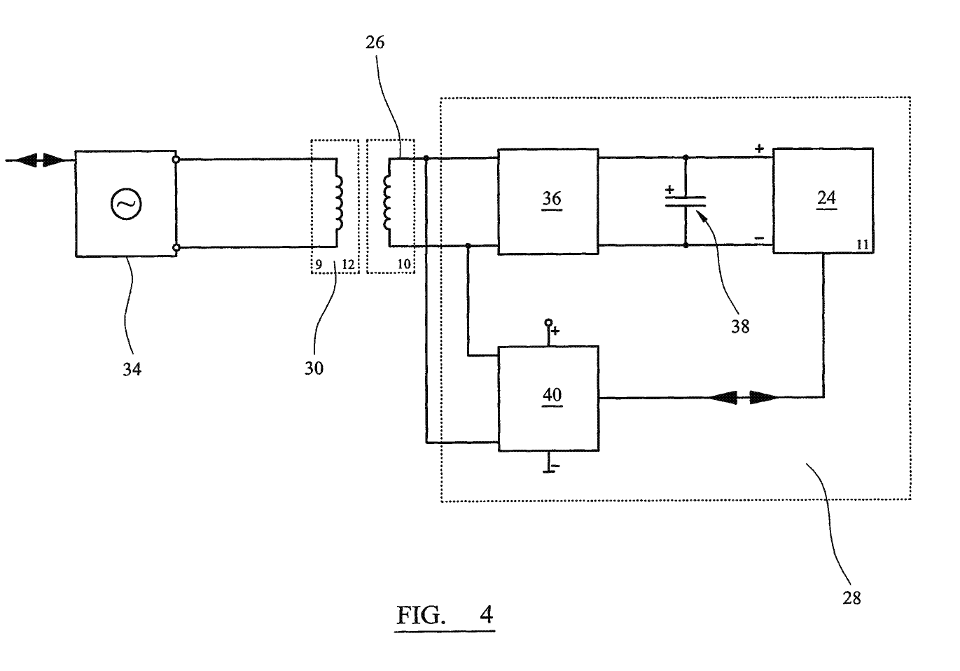

FIG. 2 shows an orientation sensor 24 such as one or more accelerometers or a magnetic sensor for indicating the orientation of the tool 4. The sensor 24 is mounted to the housing 16 at a known position relative to one of the pushers 20. A first transceiver coil 26 is mounted to the housing 16 and is connected to the sensor 24 by processing electronics 28 as shown in more detail in FIG. 4. A second transceiver coil 30 and a series of permanent magnets 32 are arranged equiangularly around the circumference of the rotary shaft 18 in positions adjacent to and facing the housing 16, so that as the shaft 18 rotates, passage of the magnets 32 past the first transceiver coil 26 generates a voltage to provide electrical power to the sensor 24, and electromagnetic coupling between the first and second transceiver coils 26, 30 enables signals to be obtained from the sensor 24 and transmitted from the second transceiver coil 30 to a measurement while drilling (MWD) tool (FIG. 1) mounted on the rotary shaft 8 of the drilling apparatus 2 upstream of the rotary steerable tool 4.

Referring to FIG. 4, as the rotary shaft 18 rotates relative to the housing 16, the magnets 32 pass the first transceiver coil 26 and generate an EMF in the first transceiver coil 26. The voltage generated in the first transceiver coil 26 is rectified by means of a rectifier 36 and delivered to the sensor 24 via a storage capacitor 38. The strength of the magnets 32 and the coupling between the first and second transceiver coils 26, 30 is selected so as to provide sufficient power for excitation of the sensor 24 at the minimum required rate of rotation of the rotary shaft 18. Signals obtained from the sensor 24 are passed via a modem/control system 40 to the first transceiver coil 26, and are then transmitted to the second transceiver coil 30 as the second transceiver coil 30 passes in close proximity to the first transceiver coil 26 with each rotation of the shaft 18. The signals are then passed to the MWD tool 34 mounted to the rotary shaft 8 of the drilling apparatus 2.

The operation of the apparatus shown in FIGS. 1, 2 and 4 will now be described. In order to monitor the direction of drilling of the drilling apparatus 2 while the shaft 8 is rotating, the signal generated by the sensor 24 provides an indication of the orientation of the housing 16 relative to the vertical, which can then be used in conjunction with static survey measurements (which will have previously been obtained while the shaft 8 is stationary) in order to determine the position and orientation of the drill bit 6. In the straight drilling mode, the housing 12 is locked to the shaft 8 by means of the clutch (not shown) and therefore rotates with the shaft. In this mode, the outer sleeve 12 is locked to the shaft 8, and therefore, during drilling the shaft 8 and sleeve 12 are locked together and rotating. The accelerometers 24 will be exposed to drilling vibrations and rotating at some speed. In addition, the entire drilling assembly is ‘straight’ i.e. operating to drill straight ahead, and therefore there is no deviation mechanism and therefore no need to identify where the sleeve 12 is positioned with respect to vertical.

In the orientating mode, however, the sleeve 12 and shaft 8 are locked together The MWD accelerometers (not shown) or the outer sleeve accelerometers 24 can be used to monitor the angle from vertical in order to ‘orient’ the tool 4 prior to excitation (cycle of pumps). This is achieved by rotating the tool 4 slowly clockwise (i.e. sufficiently slowly that the accelerometers do not become subjected to excessive vibration) and reading the angular position at the surface until the tool 4 is positioned correctly.

In the directional drilling mode, the rotary steerable tool 4 is activated by means of changes in fluid pressure to cause one or more of the pushers 20 to protrude from the housing 16 to engage the wall 22 of the borehole, which in turn causes the drilling apparatus 2 to deviate in a direction opposite to the pushers 20 engaging the borehole wall 22. At the same time, the clutch (not shown) causes the housing 12 to disengage from the shaft 8 so that the shaft 8 can rotate relative to the housing 12. The signal generated by the sensor 24 then provides an indication of the orientation of the housing 16 relative to the vertical—

FIG. 3 shows an alternative embodiment in which the permanent magnets 32 of FIG. 2 are replaced by a circumferentially wound antenna 42 on the rotary shaft 18. The antenna 42 receives an alternating current which induces an EMF the first transceiver coil 26, which can then power the sensor 24 using similar electronics 28 to that shown in FIG. 4. The circumferentially wound antenna 42 can be permanently or intermittently excited, depending upon the frequency of which data is required from the sensor 24 and the power requirements.

It will be appreciated by person skilled in the art that the above embodiments have been described by way of example only, and not in any limitative sense, and that various alterations and modifications are possible without departure from the scope of the invention as defined by the appended claims.

1. An orientation indicating apparatus for a downhole tool having a first part and a second part adapted to selectively rotate relative to said first part, the apparatus comprising:
at least one orientation sensor adapted to be mounted to said first part for providing a signal representing the orientation of said first part;
signal transmitting means adapted to be mounted to said first part and to be connected to at least one said orientation sensor; and
signal receiving means adapted to be mounted to said second part and to be in electromagnetic communication with said signal transmitting means for receiving a signal provided by at least one said orientation sensor.

2. An apparatus according to claim 1, wherein at least one said orientation sensor is an accelerometer.

3. An apparatus according to claim 1 or 2, wherein at least one said orientation sensor is a magnetic sensor.

4. An apparatus according to any one of the preceding claims, wherein said signal-transmitting means comprises at least one conductive loop adapted to transmit a signal to said signal receiving means by means of electromagnetic induction.

5. An apparatus according to any one of the preceding claims, wherein said signal receiving means is adapted to enable power to be transmitted to said sensor by means of electromagnetic induction.

6. An apparatus according to claim 5, wherein the signal receiving means comprises at least one conductive loop.

7. An apparatus according to claim 6, wherein the signal receiving means further comprises at least one magnetic material surrounded by at least one said conductive loop.

8. An apparatus according to claim 7, wherein at least one said magnetic material is a ferromagnetic material.

9. An apparatus according to any one of claims 6 to 8, wherein the signal receiving means further comprises at least one magnet.

10. An apparatus according to claim 8 or 9, wherein the signal receiving means comprises at least one antenna adapted to receive a varying electrical signal.

11. A downhole tool comprising:
a housing adapted to be mounted in a drilling apparatus for forming a borehole;
a hollow shaft defining a passage for drilling fluid, wherein at least part of said shaft is rotatably mounted in said housing; and
an orientation indicating apparatus according to any one of the preceding claims, wherein at least one said orientation sensor and said signal transmitting means are mounted to said housing and said signal receiving means is mounted to said hollow shaft.

12. A tool according to claim 11, further comprising at least one borehole engaging component mounted to said housing and displaceable relative thereto to engage a wall of a borehole formed by a drilling apparatus incorporating said downhole tool, in order to adjust the direction of drilling of said drilling apparatus.
